(19) United States
(12) Patent Application Publication
(10) Pub. No.: US 2016/0345196 A1
(43) Pub. Date: Nov. 24, 2016

(54) SYSTEM AND METHOD FOR REDUCING CELL CONGESTION LEVELS IN MOBILE NETWORKS

(71) Applicant: SAGUNA NETWORKS LTD., Yokneam Illit (IL)

(72) Inventors: Daniel Nathan Frydman, Haifa (IL); Lior Fite, Zurit (IL)

(21) Appl. No.: 14/714,372

(22) Filed: May 18, 2015

(51) Int. Cl. H04W 28/02

(52) U.S. Cl. CPC H04W 28/0289; H04W 28/0284

(57) ABSTRACT

Disclosed a methods, circuits, apparatuses and associated computer executable code for regulating congestion levels on at least one segment of a data communication network. According to some embodiments, a data communication network may include an access point along with both uplink and downlink data paths. The network may include a traffic management appliance. The appliance or functionally associated device may include a traffic monitor to measure a downlink congestion level on a segment of the network downlink. The appliance or a functionally associated device may include a transmission manager to intercept or suppress uplink data traffic when the traffic monitor indicates a downlink congestion level exceeding a first threshold level.

### FIELD OF THE INVENTION

The present invention relates generally to the field of 3G and 4G mobile networks. More specifically, the present invention relates to a system and method for reducing cell congestion levels in mobile networks by controlling the uplink bandwidth and offering local store and forward at the cell-site.

### BACKGROUND

In recent years, the use of user created content is increasing heavily, therefore increasing the demand for higher uplink bandwidth. This content may include content to be stored on internet services such as YouTube and on social networks such as Facebook, Twitter and the like. Additionally, there is a proliferation of smartphone devices and high resolution camera phones which are used to take personal photos and videos and which upload the photos to cloud storage, thereby increasing usage of cellular networks uplinks. There is also an overall increase in the use of internet cloud storage for backup of data from various services running on mobile devices.

Still, when comparing uplink traffic to downlink traffic, the ratio between uplink to downlink traffic is approximately 1 to 5.

As a result of this asymmetrical nature of data usage, specifically in 3G HSPA and in 4G FDD LTE technologies, cellular networks are usually designed asymmetrically, offering more bandwidth on the downlink than on the uplink-for example in a 4G FDD network, the mobile network operator may allocate out of a 20 MHz carriers band, 3*5 MHz for downlink traffic and only 1*5 Mhz for uplink traffic.

During peak operating hours, the downlink traffic volumes may be high enough to congest the downlink resources. Most of this traffic running over the cellular network's downlink is carried using HTTP over TCP protocols, which traffic also consumes some of the uplink bandwidth for Acks etc. If during these downlink congestion periods a device which is connected over the same cell requires uplink services and due to the fact that the down and uplink are not symmetric, the uplink may be congested as well.

As described above, HTTP and TCP protocols require uplink bandwidth to enable best downlink performance and congestion on the uplink may seriously affect the ability to utilize the entire radio bandwidth during peak hours when demand for download traffic is very high.

### SUMMARY OF THE INVENTION

The present invention may include methods, circuits, apparatuses and associated computer executable code for regulating congestion levels on at least one segment of a data communication network. According to some embodiments, a data communication network may include an access point along with both uplink and downlink data paths. The network may include a traffic management appliance. The appliance or a functionally associated device may include a traffic monitor to measure a downlink congestion level on a segment of the network downlink, for example a wireless downlink segment. The appliance or a functionally associated device may include a transmission manager to intercept or suppress uplink data traffic when the traffic monitor indicates a downlink congestion level exceeding a first threshold level.

The appliance according may further comprise a data buffer to temporarily store intercepted uplink data traffic, wherein the intercepted uplink data traffic may be released and forwarded to an intended destination upon the downlink congestion level falling below a second threshold level. According to embodiments, a receipt acknowledgement generated by the intended destination of the uplink data traffic may be intercepted or suppressed such that is does not reach the source of the uplink traffic.

An appliance according to embodiment may include an acknowledgment unit to generate a receipt acknowledgement for intercepted uplink data traffic, wherein the receipt acknowledgment may be configured to emulate a receipt acknowledgement from an intended destination of the intercepted uplink traffic. The generated receipt acknowledgement may be transmitted to the source of the uplink traffic when a congestion level of the downlink permits.

The present invention may include systems and methods for reducing cell congestion levels in mobile networks by controlling the uplink bandwidth and offering local store and forward at the cell-site. According to some embodiments of the present invention, there may be a Congestion Control Module (CCM) located within a 4G or 3G Radio Access Network (RAN) and adapted to constantly monitor the uplink and/or downlink traffic. According to some embodiments of the present invention, the CCM may determine the congestion level of either or both the downlink and the uplink Radio within a specific cell sector. According to some embodiments of the present invention, the CCM may further be capable of analyzing the demand for bandwidth either or both on the uplink and on the downlink. According to some embodiments of the present invention, the CCM may apply traffic policy on the uplink. According to some embodiments of the present invention, the CCM may also include a local store and forward element, this element may be adapted to work in conjunction with the user device and locally store the content which is being uploaded by the device to the network. According to some other embodiments of the present invention, the User Equipment (UE) may run an application that may interact with an application running in the CCM in order to time when content may be sent from the UE onto the uplink. For example, the UE may repetitively send HTTP Get messages to the CCM requesting to upload content, according to the cell congestion level on the uplink and/or downlink the CCM may reply with go/no-go to each of the HTTP Get requests coming from the UEs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an example of the CCM within a 3G network;

FIG. 2 shows an example of the CCM within a 4G network;

FIG. 3 shows an example of the CCM which includes a local store and forward within a 3G network;

FIG. 4 shows an example of the CCM which includes a local store and forward within a 4G network;

FIG. 5 is a flowchart showing an example of steps performed by the CCM for releasing congestion on the uplink;

FIG. 6 is a flowchart showing the steps taken by the CCM according to some exemplary store and forward embodiments of the present invention; and

FIG. 7 is a flowchart showing the steps taken by the UE application and the CCM application in an example according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including magnetic hard disks, solid state disks (SSD), floppy disks, optical disks, CD-ROMs, DVDs, BlueRay disks, magnetic-optical disks, read-only memories (ROMs), random access memories (RAMs) electrically programmable read-only memories (EPROMs), electrically erasable and programmable read only memories (EEPROMs), Flash memories, magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Modern mobile networks are typically designed in an asymmetrical way in which the allocated bandwidth on the downlink is higher than the uplink allocated bandwidth, a typical uplink to downlink bandwidth ratio may be about 1:3. As uplink traffic in mobile networks is growing rapidly, for instance, uploading content (e.g. photos, video clips) to internet services (e.g. YouTube, Dropbox) and/or social networks (e.g. Facebook) by proliferating smartphones having high resolution cameras, and/or performing backup of the mobile device's content on the cloud, or even by video phone calls, congestion on the uplink may occur. Since most of the traffic both on the uplink and downlink is TCP/IP, both the up and down links bandwidths are needed for the TCP session, one direction for the high bandwidth content packets, and the other direction for small acknowledge and other control packets. In the event that there is congestion on the uplink, ack packets for downlink content traffic will be delayed or dropped, and as a result the downlink traffic performance will be badly affected. The degradation in downlink performance may happen even when the downlink is not congested, or even when it is far from being congested, and depends solely on congestion in the uplink. Congestion on the uplink may even cause congestion on the downlink when otherwise is not congested, since congestion on the uplink may cause retransmission of packets on the downlink whom their ack packets on the uplink were delayed or discarded, these retransmissions increase the consumed bandwidth on the downlink and on the uplink which further congests the uplink and therefore increases the packet drop. Therefore, it might happen that there is plenty of available bandwidth on the downlink but congestion on the uplink may seriously affect the ability to utilize the entire downlink radio bandwidth since much of this bandwidth will be consumed for retransmission of packets due to discarded or delayed acks of these packets on the uplink. This positive gain effect may eventually cause congestion on the downlink which should be avoided.

The present invention is a system and method for solving the problem created by applications residing on smartphones and other devices connected over the 3G or 4G networks that are using the uplink connection and therefore limiting the ability of TCP and HTTP traffic from utilizing the available downlink radio resource in 3G and 4G cell sectors.

The system and method according to the present invention, solves the above problem by having a SW or HW system or a combination of the two as part of a Congestion Control Module (CCM), that may be located within a 4G or 3G Radio Access Network (RAN) for example as part of a 4G or a 3G base station or in a Radio Network Controller (RNC) or in any other location within the Radio Access Network.

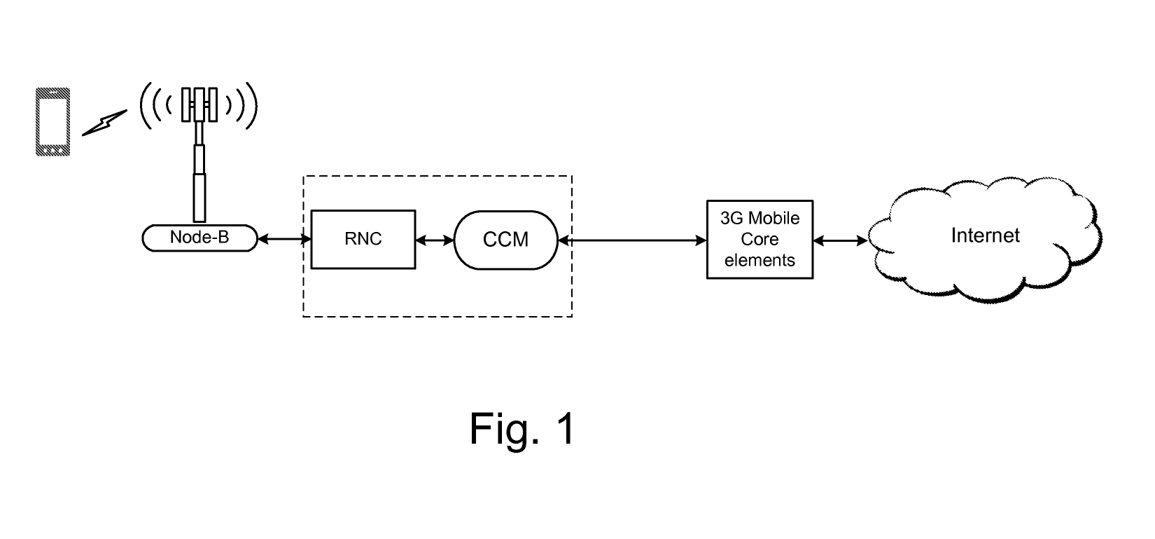

FIG. 1 shows an example of the CCM within a 3G network. In this example the CCM is part of or adjacent to the Radio Network Controller (RNC).

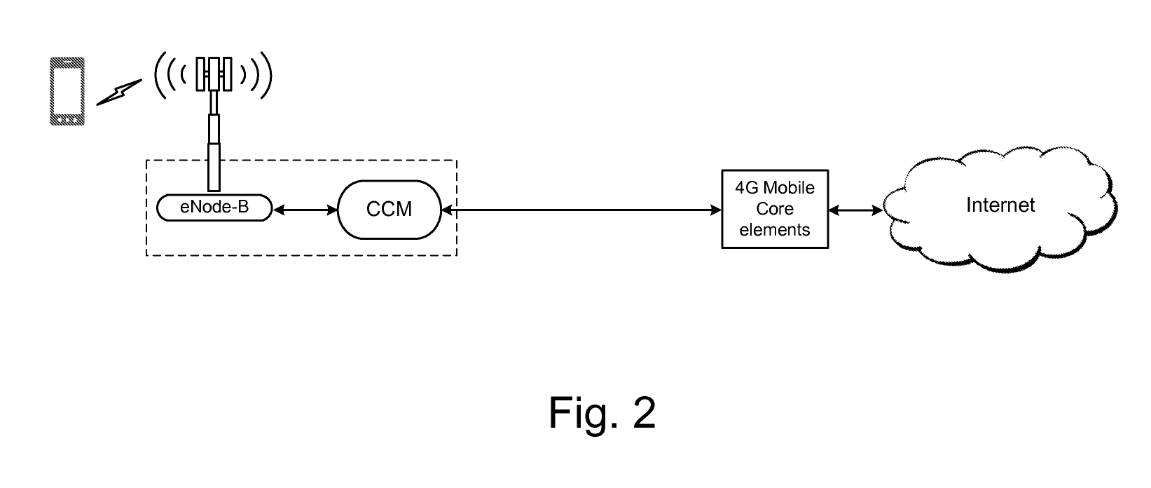

FIG. 2 shows an example of the CCM within a 4G network. In this example the CCM is part of or adjacent to the base station.

According to some embodiments of the present invention, the CCM may constantly monitor the uplink and/or downlink traffic and by using Deep Packet Inception and Deep Flow Inception technology, may recognize and classify the flows, for example, TCP, HTTP, HTTPS flows, and the applications which are running over these HTTP flows that are using the uplink connection. According to further embodiments of the present invention, the CCM may be capable of determining by itself or by receiving indications from other Radio Access Network equipment, for example a 3G or 4G base station, the congestion level of the uplink and/or the downlink Radio within a specific cell sector that carries these flows. According to further embodiments of the present invention, the CCM may be capable of analyzing the demand for bandwidth on the downlink and/or on the uplink. When the CCM recognizes that the uplink traffic is congested, the CCM may apply traffic policy for example by means of a token bucket, or by means of delaying TCP ACK messages on the downlink, for example on the TCP, HTTP, HTTPS flows that are consuming the uplink, in order to release the congestion on the Radio Uplink Resource. According to even further embodiments of the present invention, The CCM may monitor the effect of reducing the congestion level on the uplink on the downlink bandwidth and may make further decisions to continue the traffic shaping on the uplink flows or to terminate it.

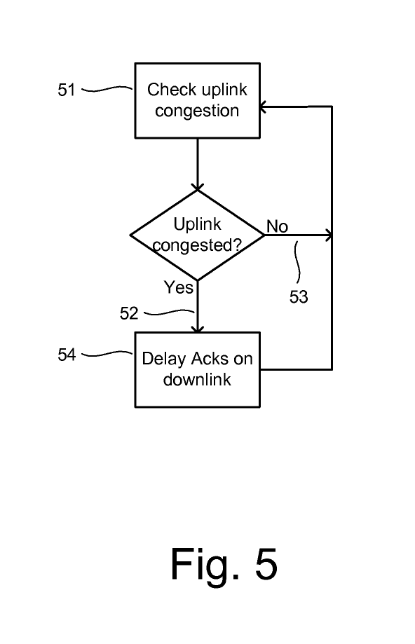

FIG. 5 is a flowchart showing an example of the actions taken by the CCM for releasing congestion on the uplink. In this example the CCM monitors the uplink to determine if it is congested (51), if the uplink is found not to be congested (53) the CCM keeps monitoring the uplink, when congestion is detected on the uplink (52) the CCM starts delaying Ack packets on the downlink in order to slow down the session on the uplink.

According to some embodiments of the present invention, the CCM may also include a local store and forward element, this element may be adapted to work in conjunction with the user device and locally store the content which is being uploaded by the device to the network. According to some embodiments of the present invention, there may be a local store and forward application in the local store and forward element which may terminate traffic going from the user device, for example TCP, HTTP or HTTPS traffic, at a location which is closer to the device, and therefore reducing the Round Trip Time between the device and the storage element. This reduction in Round Trip Time is a further improvement of the ability to control the rate of the radio uplink, as this local Store and Forward application that may be connected to the device within the Radio Access Network either directly or through a local Breakout mechanism for example Traffic Offload Function or Selective IP Traffic Offload or any other mobile traffic offload mechanism that is known today or that may be devised in the future, can receive the same radio link congestion level information of a specific Cell Sector that may carry this traffic both on the uplink and downlink directions. According to some embodiments of the present invention, the local Store and Forward application may use the congestion information received to control the rate of uplink data flows terminated by it.

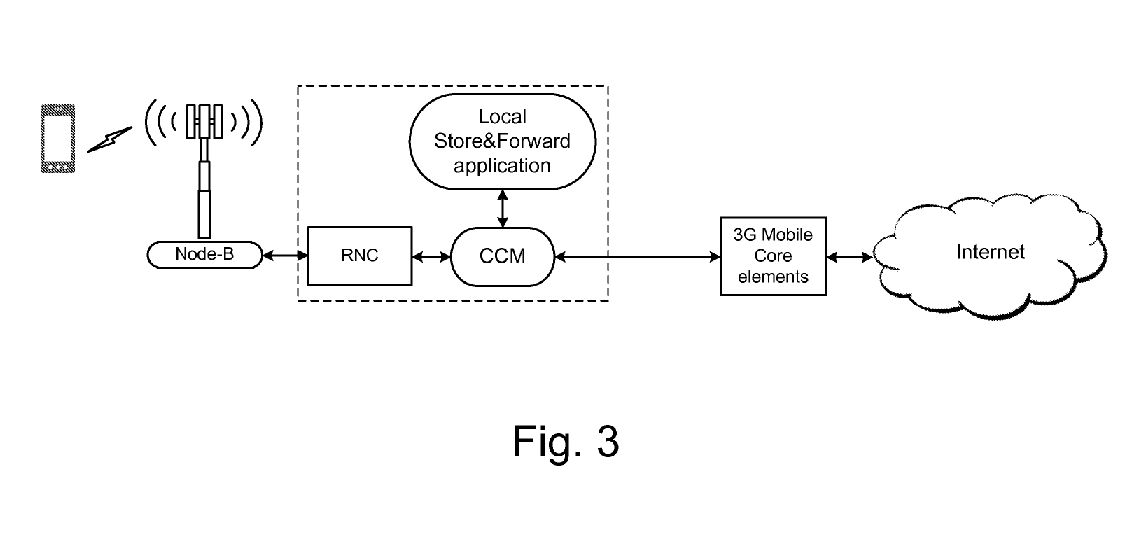

FIG. 3 shows an example of the CCM which includes a local store and forward, within a 3G network. In this example the CCM and local store and forward are part of or adjacent to the Radio Network Controller (RNC).

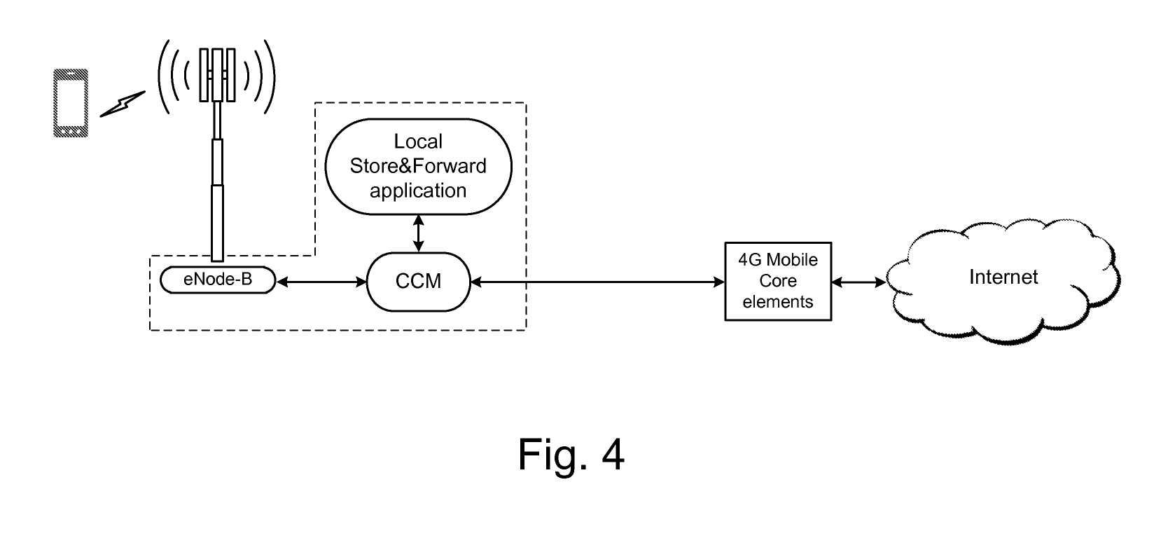

FIG. 4 shows an example of the CCM which includes a local store and forward, within a 4G network. In this example the CCM and local store and forward are part of or adjacent to the base station.

According to some embodiments of the present invention, in which the CCM terminates the session and performs local store and forward, there may be a need to continue the connection between the device and the application even during mobility events. In addition, there may be a need to record real-time charging and billing information, and to support Lawful Interception and policy enforcement. This may be done for example by means of copying locally stored data to the mobile network elements that support Charging, Lawful Interception and Policy. The techniques for supporting the above are described by the inventor of the present invention in U.S. patent application Ser. No. 14/045,047, filed Oct. 3, 2013, the disclosures of which are incorporated herein by reference in their entirety.

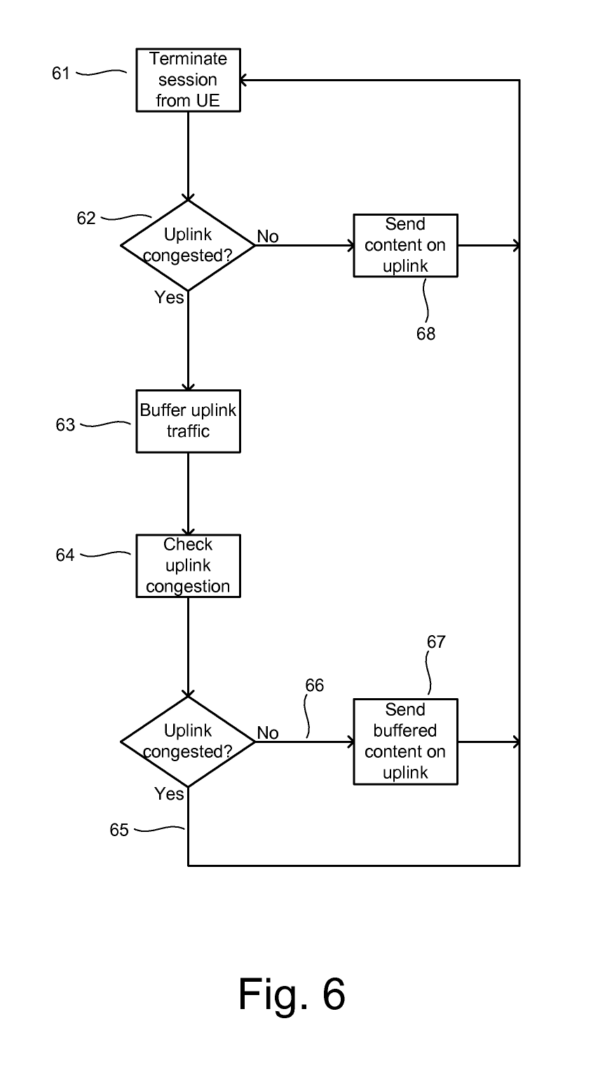

FIG. 6 is a flowchart showing the steps taken by the CCM according to some exemplary store and forward embodiments of the present invention. In this example, the CCM terminates the UE session (61) for instance at the base station. The CCM checks the congestion level on the uplink (62), if the uplink is free and has enough bandwidth to accommodate the upload traffic, the content will be transmitted over the uplink (68). If the uplink is congested or does not have enough bandwidth left for the upload, the CCM stores the content uploaded from the UE in its local store and forward memory (63). The CCM keeps monitoring the uplink congestion level (64), if the uplink remains congested (65) the CCM keeps storing the content uploaded from the UE in its local store and forward memory, if the uplink becomes free or the traffic on the uplink is low enough (66) to enable uploading the stored content, the CCM sends the stored content over the uplink (67), the CCM can send the content over the uplink at a rate which will not cause congestion on the uplink.

According to some embodiments of the present invention, an application may run in the CCM in parallel to an application running in the UEs. The UE application may communicate with the CCM application in order to time when content may be sent from the UE onto the uplink. For example, the UE may repetitively send HTTP Get messages towards the application running in the CCM requesting to upload content. The application running in the CCM may aggregate these requests and according to the cell congestion level on the uplink and perhaps also on the downlink may reply with go/no-go to each or the HTTP Get requests coming from the UE applications. Upon a UE receiving a “go”, it may start uploading the content according to the mechanisms described in embodiments of the present invention.

According to some embodiments of the present invention, there may be a User Equipment (UE) which may run an application that will control content uploading. The application will be aware of the device's will to upload data, for example by constantly checking when the UE desires to send content over the uplink, or by getting a request to upload data from another application running on the UE. Upon determining that the UE is interested in sending content over the uplink, the application may communicate with a functionally associated application in the CCM. The UE application may request permission from the CCM application to upload content over the uplink. According to some embodiments of the present invention, the CCM application may constantly or periodically or upon an upload request from the UE application, gather information regarding the uplink congestion level and perhaps also the downlink congestion level. According to the congestion level, the CCM application may decide whether to allow the UE to upload content over the uplink. According to some embodiments of the present invention, if the uplink is congested or substantially near being congested, the CCM application may deny or defer the UE application's upload request, upon congestion on the uplink being released, or if the uplink was not congested to begin with, the CCM application may enable the UE application to send data over the uplink. According to some embodiments of the present invention, the CCM application may decide the amount of bandwidth it should allocate to the UE for the content upload so that it will not congest the uplink.

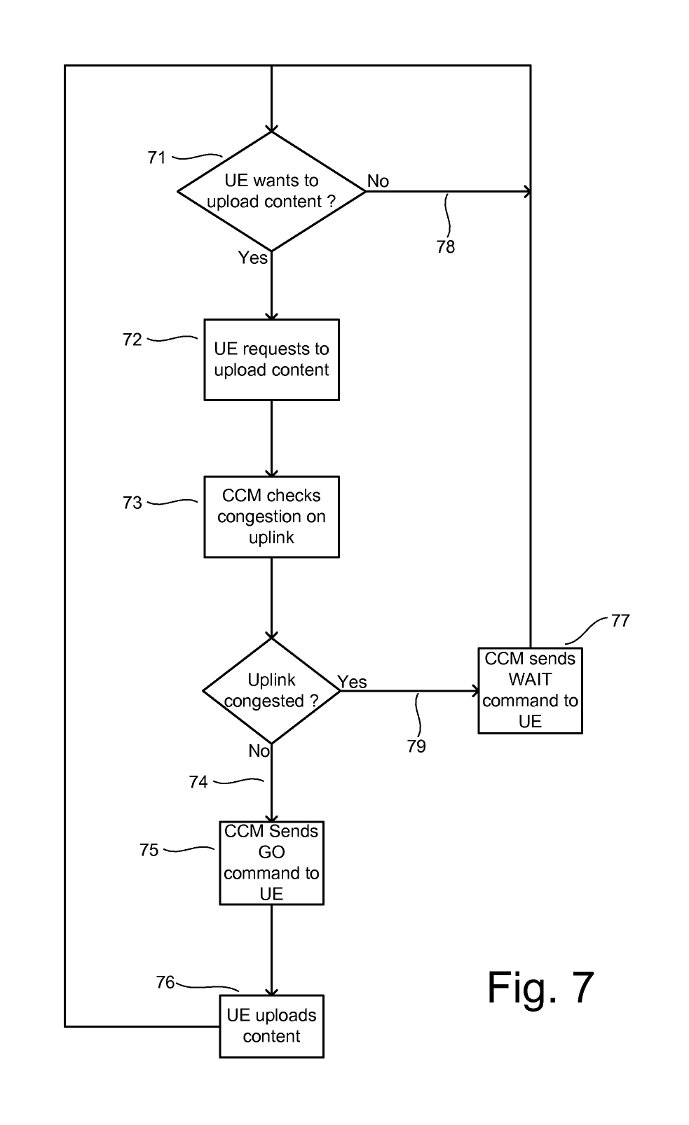

FIG. 7 is a flowchart showing the steps taken by the UE application and the CCM application in an example according to some embodiments of the present invention. In this example, the UE application waits until the UE has content to upload (71,78), when the UE application has content to upload it requests permission from the CCM application to upload the content (72). The CCM application either knows the congestion level on the uplink from continuously or periodically monitoring the uplink congestion level, or upon receiving an upload request from the UE application it may check the uplink congestion level (73). If the uplink is congested (79), the CCM application sends a WAIT command to the UE application (77), otherwise, if the uplink is not congested (74) and has enough bandwidth for the upload to take place without congesting the uplink, the CCM application sends a GO command to the UE application (75). Upon receiving a GO command from the CCM, the UE uploads the content over the uplink (76).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A data traffic management appliance for a mobile communication network, said appliance comprising:
a traffic monitor to measure a downlink congestion level on a segment of the network downlink; and
a transmission manager to intercept or suppress uplink data traffic when said traffic monitor indicates a downlink congestion level exceeding a first threshold level.

2. The appliance according to claim 1, further comprising a data buffer to temporarily store intercepted uplink data traffic.

3. The appliance according to claim 2, wherein the intercepted uplink data traffic is released and forwarded to an intended destination upon the downlink congestion level falling below a second threshold level.

4. The appliance according to claim 3, wherein a receipt acknowledgement generated by the intended destination of the uplink data traffic is intercepted or suppressed.

5. The appliance according to claim 1, further comprising an acknowledgment unit to generate a receipt acknowledgement for intercepted uplink data traffic, wherein the receipt acknowledgment is configured to emulate a receipt acknowledgement from an intended destination of the intercepted uplink traffic.

6. The appliance according to claim 5, wherein the generated receipt acknowledgement is transmitted to the source of the uplink traffic when a congestion level of the downlink permits.

7. The appliance according to claim 1, wherein the traffic monitor measures a downlink congestion level on a wireless segment of the downlink.

8. A data traffic network comprising:
a least one wireless access point; and
a traffic management appliance comprising: (a) a traffic monitor to measure a downlink congestion level on a segment of the network downlink; and (b) a transmission manager to intercept or suppress uplink data traffic when said traffic monitor indicates a downlink congestion level exceeding a first threshold level.

9. The network according to claim 8, further comprising a data buffer to temporarily store intercepted uplink data traffic.

10. The network according to claim 9, wherein the intercepted uplink data traffic is released and forwarded to an intended destination upon the downlink congestion level falling below a second threshold level.

11. The network according to claim 10, wherein a receipt acknowledgement generated by the intended destination of the uplink data traffic is intercepted or suppressed.

12. The network according to claim 8, further comprising an acknowledgment unit to generate a receipt acknowledgement for intercepted uplink data traffic, wherein the receipt acknowledgment is configured to emulate a receipt acknowledgement from an intended destination of the intercepted uplink traffic.

13. The network according to claim 12, wherein the generated receipt acknowledgement is transmitted to the source of the uplink traffic when a congestion level of the downlink permits.

14. The network according to claim 8, wherein the traffic monitor measures a downlink congestion level on a wireless segment of the downlink.

15. A method of managing data traffic on a mobile communication network, said method comprising:
measuring a downlink congestion level on a segment of the network downlink; and
intercepting or suppressing uplink data traffic when a downlink congestion level exceeds a first threshold level.

16. The method according to claim 15, further comprising buffering intercepted uplink data traffic.

17. The method according to claim 16, wherein the intercepted uplink data traffic is released and forwarded to an intended destination upon the downlink congestion level falling below a second threshold level.

18. The method according to claim 17, further comprising intercepting or suppressing a receipt acknowledgement generated by the intended destination of the uplink data traffic.

19. The method according to claim 15, further comprising generating a receipt acknowledgement for intercepted uplink data traffic, wherein the receipt acknowledgment is configured to emulate a receipt acknowledgement from an intended destination of the intercepted uplink traffic.

20. The method according to claim 19, wherein the generated receipt acknowledgement is transmitted to the source of the uplink traffic when a congestion level of the downlink permits.
